(19) United States
(12) Patent Application Publication
(10) Pub. No.: US 2020/0411259 A1
(43) Pub. Date: Dec. 31, 2020

(54) CIRCUIT BREAKER FOR ISOLATING AN ELECTRICAL CIRCUIT

(71) Applicant: ELLENBERGER & POENSGEN GMBH, ALTDORF (DE)

(72) Inventors: KLAUS LOOS, WINKELHAID (DE); KLAUS WERNER, ROETHENBACH (DE)

(21) Appl. No.: 17/022,329

(22) Filed: Sep. 16, 2020

Related U.S. Application Data
(63) Continuation of application No. PCT/EP2019/055812, filed on Mar. 8, 2019.

(30) Foreign Application Priority Data
Mar. 16, 2018 (DE) 102018204104

(51) Int. Cl. H01H 33/18; H01H 33/53

(52) U.S. Cl. CPC H01H 33/182; H01H 33/53

(57) ABSTRACT

A circuit breaker includes a switching unit for interrupting an electrical circuit. The switching unit has a stationary fixed contact and a moving contact to be moved relative to the fixed contact and to be switched from a closed position to an open position. A quenching device for quenching an arc when the contacts are opened includes a prechamber for guiding the arc from the contacts to a quenching chamber. The prechamber has two insulating side walls and a pair of arc guide rails situated therebetween. A ferromagnetic shaped part is disposed on each of the side walls, and a permanent magnet is disposed in the region of the fixed contact. The magnetic field of the permanent magnet guides the arc along one of the arc guide rails.

### CROSS-REFERENCE TO RELATED APPLICATION

This application is a continuation, under 35 U.S.C. § 120, of copending International Application PCT/EP2019/055812, filed Mar. 8, 2019, which designated the United States; this application also claims the priority, under 35 U.S.C. § 119, of German Patent Application DE 10 2018 204 104, filed Mar. 16, 2018; the prior applications are herewith incorporated by reference in their entirety.

### BACKGROUND OF THE INVENTION

### Field of the Invention

The invention relates to a circuit breaker including a switching unit as an isolating apparatus for interrupting an electrical circuit, having a stationary fixed contact and a moving contact which can be moved relative to the fixed contact and can be transferred from a closed position to an open position, and a quenching device for quenching an arc which is produced when the contacts are opened, including a prechamber for guiding the arc from the contacts to a quenching chamber.

Reliable isolation of electrical components or devices from a switching or electrical circuit is desirable, for example, for installation, assembly or servicing purposes and also, in particular, for general personal protection as well. In that case, a corresponding switching unit or isolating apparatus has to be able to perform interruption under load, that is to say without first disconnecting a voltage source which feeds the electrical circuit. Mechanical switches (switching contact) can be used for load isolation. The mechanical switches have the advantage that, when the contact is successfully opened, DC isolation of the electrical device from the voltage source is likewise established.

Particularly in the case of DC voltages of above 24 V (DC) which are to be switched, switching arcs often occur, when electrical contacts through which current flows are isolated, by way of the electric current continuing to flow along an arc section in the form of an arc discharge after the contacts are opened. Since, under certain circumstances, switching arcs of that kind are not automatically quenched in the case of DC voltages starting from approximately 50 volts and direct currents starting from approximately 1 ampere, so-called snap-action contacts, in the case of which mechanical springs are employed for accelerating the contact isolation, are employed as a mechanical contact system for example.

The arcs which are produced when the contacts are opened under load are rapidly moved into quenching devices provided for them, where the appropriate arc quenching takes place. The force which is required for that purpose is provided for example by magnetic fields, so-called blowing fields, which are typically generated by one or more permanent magnets. Special construction of the contact zones and of the arc conducting piece routes the arc into appropriate quenching chambers, where the arc quenching takes place on the basis of known principles.

Basic measures for preventing or managing switching arcs of that kind substantially involve employing an insulating material for the purpose of increasing the dielectric strength and therefore for the purpose of arc quenching even in the case of a small contact clearance or reducing the arc voltage by splitting the arc.

German Utility Model DE 20 2006 021 064 U1, corresponding to U.S. Pat. Nos. 8,098,119; 7,978,033; and 7,834,290, describes a circuit breaker including a switching unit in which a (switching) arc which is produced when a contact system is opened is quenched by using a quenching device. The quenching device has a prechamber with two arc guide rails which are disposed between two isolating side or covering walls as a lateral boundary for arc guidance. The arc is guided by using the prechamber to a quenching chamber, and quenched there.

### BRIEF SUMMARY OF THE INVENTION

It is accordingly an object of the invention to provide a particularly suitable circuit breaker for isolating an electrical circuit, which overcomes the hereinafore-mentioned disadvantages of the heretofore-known circuit breakers of this general type.

With the foregoing and other objects in view there is provided, in accordance with the invention, a circuit breaker comprising a switching unit for interrupting an electrical circuit, the switching unit including:

a stationary fixed contact and a moving contact which can be moved relative to the fixed contact and can be transferred from a closed position to an open position;

a quenching device for quenching an arc which is produced when the contacts are opened, including a prechamber for guiding the arc from the contacts to a quenching chamber, the prechamber having two insulating side walls and a pair of arc guide rails which are situated therebetween;

a ferromagnetic shaped part disposed on each of the side walls; and

a permanent magnet disposed in the region of the fixed contact, the magnetic field of the permanent magnet guiding the arc along one of the arc guide rails.

With the objects of the invention in view, there is also provided a circuit breaker, comprising a switching unit for interrupting an electrical circuit, the switching unit including:

a stationary fixed contact and a moving contact which can be moved relative to the fixed contact and can be transferred from a closed position to an open position;

a quenching device for quenching an arc which is produced when the contacts are opened, including a prechamber for guiding the arc from the contacts to a quenching chamber, the prechamber having two insulating side walls and a pair of arc guide rails which are situated therebetween; and

a shaped magnet disposed on each of the side walls, the common magnetic field of the shaped magnet guiding the arc along one of the arc guide rails.

The circuit breaker according to the invention is suitable and constructed for interrupting an electrical circuit, in particular a DC circuit. The circuit breaker is therefore constructed as a switching device for manually and/or automatically disconnecting electrical circuits or individual loads when permissible current or voltage values are exceeded (overcurrent, residual current).

To this end, the circuit breaker has a switching unit as an isolating apparatus with a switchable mechanical contact system. Here and below, “switching” is understood to mean, in particular, mechanical or DC contact isolation (“opening”) and/or contact closing (“closing”) of the contact system.

The contact system has a stationary fixed contact and a moving contact. In this case, the moving contact can be moved relative to the fixed contact and can be transferred from a closed position to an open position. This means that the moving contact is moved between the open position and the closed position for the purpose of switching the contact system or the switching unit.

Furthermore, the switching unit has a quenching device for quenching a (switching) arc which is produced when the contacts are opened. The quenching device is constructed with a quenching chamber for quenching the switching arc and also with a prechamber for guiding the arc from the contacts to the quenching chamber.

The prechamber has two insulating side walls as lateral covering plates, wherein a pair of arc guide rails are situated between the side walls. The prechamber is therefore open at the end sides on either side, wherein one end side faces the contact system and the other end side faces the quenching chamber. The prechamber therefore forms an arc guide space which is delimited toward the sides by using the insulating side walls as covering plates and the arc guide rails for guiding the arc. The transition of the arc from the contacts of the contact system to the adjoining arc guide rails of the prechamber is also referred to as commutation in the text which follows.

The quenching chamber suitably has an inlet, which faces the open end side of the prechamber, and an oppositely disposed outlet for the gas flow of the arc.

According to the invention, in a first embodiment of the invention, a ferromagnetic shaped part, which is preferably matched to the profile of the arc guide rails, is disposed on each of the side walls. The shaped parts are produced in a simple manner, for example as stamped parts. In this case, the shaped parts are preferably attached outside the arc guide space, that is to say to the outer side of the side walls of the prechamber. The shaped parts surround the arc guide space of the prechamber substantially over the entire surface area.

In this embodiment, a permanent magnet is additionally disposed in the region of the fixed contact, the magnetic field of the permanent magnet guiding the arc along one of the arc guide rails. This renders possible particularly rapid and effective quenching of an arc which is produced. Therefore, a particularly effective and operationally safe switching unit is realized.

The ionized (switching) arc is forced or channeled in the direction of the quenching chamber due to the electrodynamic interactions with the magnetic field of the permanent magnet. Firstly, bundling or focusing of the magnetic field in the immediate contact region of the contacts is realized by the ferromagnetic shaped parts as side plates. Secondly, the arc magnetic field, which accompanies the arc, in the vicinity of a ferromagnetic material attempts to run through the shaped parts which are magnetically more conductive. This creates a “suction effect” in the direction of the shaped parts which leads to the arc moving to the prechamber.

The ferromagnetic shaped parts are at least partially magnetized by the magnetic field of the permanent magnet, so that the magnetic field or its magnetic field lines is/are effectively bundled, that is to say concentrated or focused, between the arc guide rails. Particularly uniform and rapid arc guidance into the quenching stack is created by this concentrated bundling of the magnetic field.

The permanent magnet is suitably manufactured from a heat-resistant material. This means that the permanent magnet is manufactured from a magnetic material which retains its magnetic properties even at high temperatures, as occur in the region of the arc in particular. In other words, for example, a magnetized ferromagnetic material is used for the permanent magnet, the material-specific Curie point of the material being greater than the temperature expected in the region of the arc.

The permanent magnet is produced, for example, from a samarium alloy, in particular a samarium-cobalt alloy, preferably Sm₂Co₁₇, or a neodymium alloy, in particular neodymium-NiCuN, or an aluminum alloy, in particular AlNiCo500. In this case, the permanent magnet generates a magnetic field with a magnetic field strength of between 900 mT (milli Tesla) and 1500 mT, in particular of between 1000 mT and 1250 mT.

As a result, the arc is commutated particularly rapidly from the fixed contact to the guide rails, and therefore drawn away from the contact system. Therefore, the contact material losses in the region of the contacts due to the formation of an arc are reduced. Furthermore, the arc is moved in a particularly stable and rapid manner on the arc guide rail by the magnetic field which is concentrated by using the shaped parts.

In a preferred embodiment, the quenching device is optimized to the effect that a switching arc is “sucked” into the quenching chamber in a rapid and effective manner by using the prechamber and the permanent magnet, without passing through the quenching chamber and back-igniting at the outlet or bouncing off the quenching chamber and back-igniting before its inlet. A particularly effective quenching device is realized due to the rapid and reliable guidance of the arc by using the prechamber, and therefore the quenching chamber can be constructed with a particularly flat construction with sufficiently good quenching behavior. A switching unit which is particularly compact with respect to installation space is rendered possible in this way.

In a conceivable refinement, two shaped magnets are provided in addition to the permanent magnet for the purpose of guiding the arc. In this case, the permanent magnet is suitably disposed between the shaped magnets. This ensures particularly reliable and operationally safe guidance of the arc to the quenching chamber.

The advantages and preferred refinements outlined with respect to the above-described first embodiment are analogously also applicable to the alternative embodiment described below, and vice versa.

In a second, alternative embodiment of the invention, the switching unit has, in contrast to the above-described embodiment, in particular in each case one shaped magnet instead of the shaped parts, wherein the common magnetic field which is generated by the shaped magnets guides the arc along one of the arc guide rails.

In this case, the shaped magnets have substantially the same geometric shape or contour as the ferromagnetic shaped parts. Therefore, it is conceivable, for example, to construct the shaped parts and the shaped magnets to be exchangeable for one another.

The shaped magnets can selectively be used with or without the permanent magnets. A combination of at least one ferromagnetic shaped part and at least one shaped magnet and also with or without the permanent magnets is also conceivable for example.

In contrast to the shaped parts, the shaped magnets, in the absence of the permanent magnet, also always have a magnetization which generates the magnetic field for guiding the arc.

The circuit breakers according to the invention therefore each have a particularly effective quenching device for quenching switching arcs which occur. Due to the improved quenching behavior of the quenching device of the circuit breakers, the quenching device can be constructed with a particularly flat construction. This renders possible a flat construction of the circuit breaker, as a result of which use in installation spaces of reduced installation space, such as in switchgear cabinets for example, is improved.

In an advantageous development, the arc guide rail along which the arc is guided by the magnetic field of the permanent magnet and/or of the shaped magnets is guided to the fixed contact. In this case, the arc guide rail has a curved or bent profile from the fixed contact toward the quenching chamber. A particularly expedient and operationally safe profile of the arc guide rail is realized in this way.

In one possible refinement, this (first) arc guide rail connects the fixed contact to a first side wall of the quenching chamber. The arc guide rail has, starting from the fixed contact, a convex profile due to the bend. Due to the curvature or bend, the arc is guided away from the fixed contact in a particularly reliable manner, and therefore material loss or wear of the fixed contact is reduced.

The other (second) arc guide rail preferably connects a stop surface, against which the moving contact bears in the open position, to a second side wall of the quenching chamber, and therefore reliable commutation of the arc is rendered possible in the region of the moving contact too.

In a suitable development, the first side wall of the quenching chamber is constructed, in particular, as a magnet yoke of a short-circuit release of a release mechanism of the circuit breaker. The (first) arc guide rail is constructed, in particular, integrally with the magnet yoke.

In an advantageous embodiment, the permanent magnet is disposed in the region of the bend or curvature of the arc rail.

In a particularly suitable refinement, the permanent magnet is disposed radially on the inside of the (first) arc guide rail with respect to the bending radius of the bend or curvature. When the permanent magnet is disposed radially on the inside in this way, the permanent magnet is therefore disposed outside the prechamber. In particular, the permanent magnet is therefore at least partially surrounded or enclosed by the (first) arc guide rail. In the case of a convex profile of the (first) arc guide rail, the arc guide rail is therefore guided approximately in a U shape or V shape around the permanent magnet. Therefore, the permanent magnet is protected against direct contact with the arc in a reliable and structurally simple manner. The service life of the permanent magnet is substantially improved in this way.

In an alternative refinement, it is likewise conceivable, for example, for the permanent magnet to be disposed radially on the outside, that is to say outside the arc guide rail, and therefore within the arc guide space of the prechamber.

In an expedient construction, the ferromagnetic shaped parts and/or the shaped magnets each have an electrical insulation at the end sides which are oriented toward the quenching chamber. In other words, the shaped parts or shaped magnets are provided with an insulation toward the inlet of the quenching chamber. This prevents an electrical short circuit along the quenching chamber and the shaped parts or shaped magnets. As a result, this can advantageously be carried over to the service life of the quenching device and therefore of the switching unit.

In a preferred embodiment, the shaped parts or shaped magnets, as insert parts, are encapsulated by injection-molding with the insulation in the region of the end sides. In an alternative embodiment, the end sides of the shaped parts or shaped magnets are inserted, in particular, into an insulating part. In other words, the insulations are molded and/or injection-molded or inserted on the ferromagnetic shaped parts or shaped magnets by process engineering. This means that the shaped part or the shaped magnets and the insulation are constructed, in particular, as a composite part. This ensures particularly simple and inexpensive production and insulation of the shaped parts or shaped magnets. Therefore, a particularly cost-effective circuit breaker is realized.

An additional or further aspect of the invention provides that the quenching chamber is constructed as a deionization chamber with an arc splitter stack, that is to say with a splitter stack with a number of splitter plates or scatter plates. Materials used for the splitter plates are, for example, ferromagnetic materials since the magnetic field, which accompanies the arc, in the vicinity of a ferromagnetic material attempts to run through the splitter plates which are magnetically more conductive. This creates a suction effect in the direction of the splitter plates which leads to the arc moving to the configuration of the splitter plates and being split between the splitter plates.

In a preferred refinement, the moving contact of the switching unit used is disposed on a pivotable switching arm which is coupled to a manual operating mechanism for manually adjusting the switching arm between the open position and the closed position and to a release mechanism for automatically returning the switching arm to the open position when a release condition occurs. A particularly suitable circuit breaker is realized in this way.

The manual operating mechanism has, for example, a pivot lever which is coupled to the switching arm by using a mechanism. The mechanism has, for example, a spring element, expediently a torsion spring, which pretensions the pivot lever in the direction of a first pivot position which corresponds to the open position of the switching arm, so that the pivot lever always automatically returns to the first pivot position in the unloaded state. In a second pivot position which corresponds to the closed position of the switching arm, the pivot lever is, in contrast, preferably locked by way of the mechanism latching with the switching arm which is in the closed position. The switching arm and the manual operating device are expediently matched to one another in such a way that, when the switching arm returns to the open position and the pivot lever returns to the first pivot position, the mechanism automatically latches with the switching arm, so that the switching arm can readily be immediately readjusted by using the manual operating mechanism.

The release mechanism preferably has a short-circuit release which is constructed to operate the release mechanism in the case of an electrical short circuit as a release condition. The short-circuit release has, for example, a magnet coil, a magnet yoke and a magnet armature, wherein the magnet yoke forms, in particular, a first side wall of the quenching chamber.

In addition or as an alternative to the short-circuit release, the release mechanism preferably has an overload release or overcurrent release. The overload release is formed, for example, substantially by a bimetallic strip which heats up as a result of the current flow and in so doing deforms in such a way that it operates the release mechanism and therefore the switching arm or the contact system in the event of overloading, that is to say given the associated release condition.

In a suitable development, the switching unit and the release mechanism and also the manual operating mechanism are at least partially accommodated in a common switching housing. Reliable touch protection (finger protection) is realized in this way.

In this case, the side walls of the switching unit are oriented parallel to the end sides of the switching housing, wherein a gap region, that is to say a clear distance, is formed between the prechamber and the switching housing. A gap region of this kind is particularly advantageous for pressure equalization during the course of arc quenching. In this case, the gap region is preferably open at the end sides of the prechamber, that is to say toward contacts and toward the inlet. The arc pushes a pressure wave in front of it in the prechamber due to the sudden heating of air, it being possible for the pressure wave to prevent the arc from entering the quenching chamber. Due to the gap region between the switching housing and the prechamber, pressure equalization is possible in front of and behind the prechamber, and therefore the arc is not prevented from entering the quenching chamber. This ensures particularly operationally safe and reliable quenching of the arc.

Other features which are considered as characteristic for the invention are set forth in the appended claims.

Although the invention is illustrated and described herein as embodied in a circuit breaker for isolating an electrical circuit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a circuit breaker;

FIG. 2 is a perspective view of a switching unit of the circuit breaker including a contact system and including a quenching unit which has a prechamber with two side walls and also a quenching chamber;

FIG. 3 is a perspective view of the switching unit of FIG. 2 with a side wall removed;

FIG. 4 is a perspective view of an alternative embodiment of the switching unit including a manual operating mechanism and including a release mechanism of the circuit breaker; and

FIG. 5 is an enlarged, fragmentary, elevational view of the embodiment according to FIG. 4.

### DETAILED DESCRIPTION OF THE INVENTION

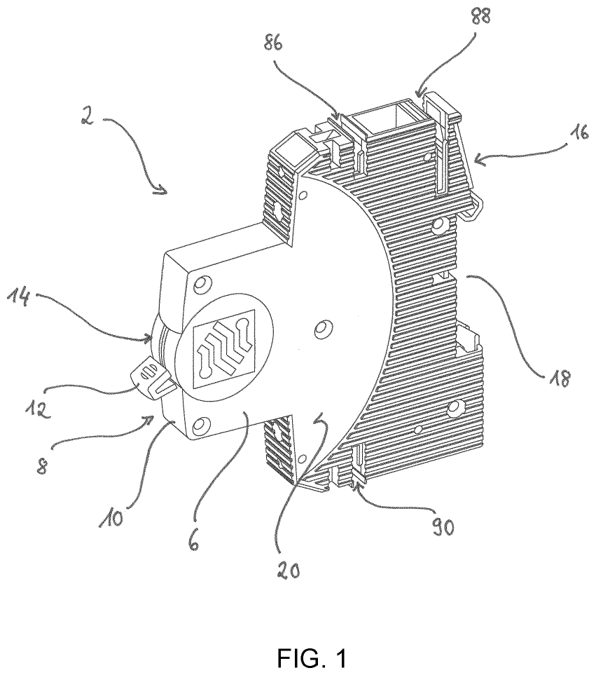

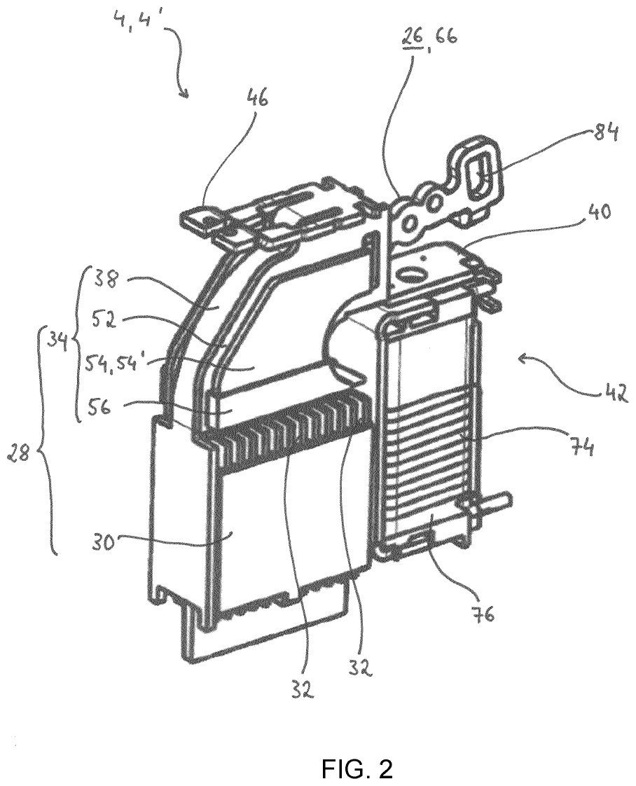

Referring now in detail to the figures of the drawings, in which parts and sizes which correspond to one another are always provided with the same reference signs, and first, particularly, to FIG. 1 thereof, there is seen a circuit breaker 2 for interrupting an electrical circuit. To this end, the circuit breaker 2 has a switching unit 4 which is explained in more detail with reference to FIGS. 2 to 5. The circuit breaker 2 furthermore has a switching housing 6 composed of an insulating material.

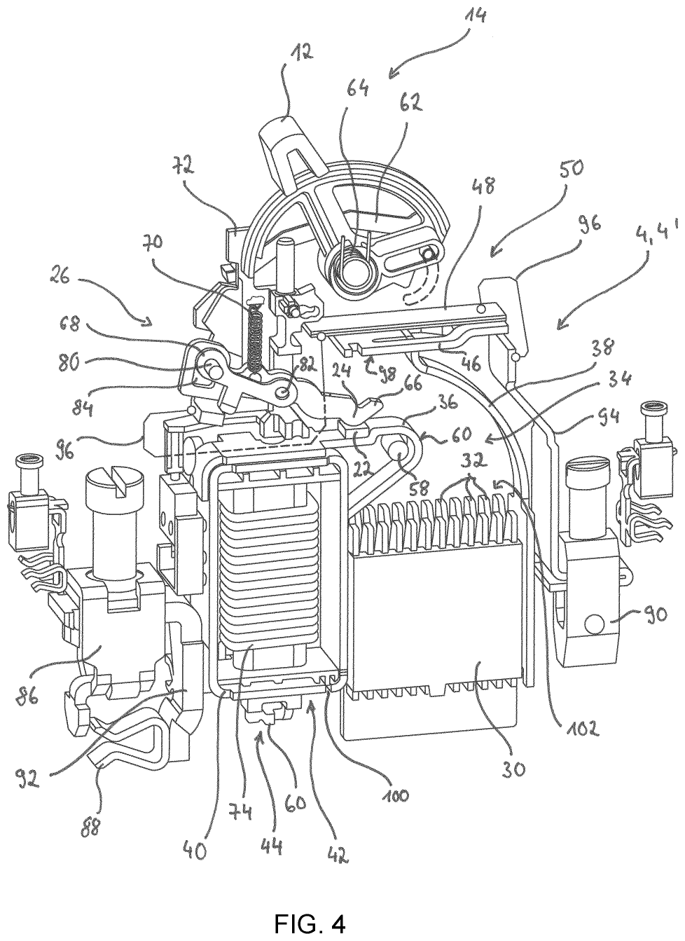

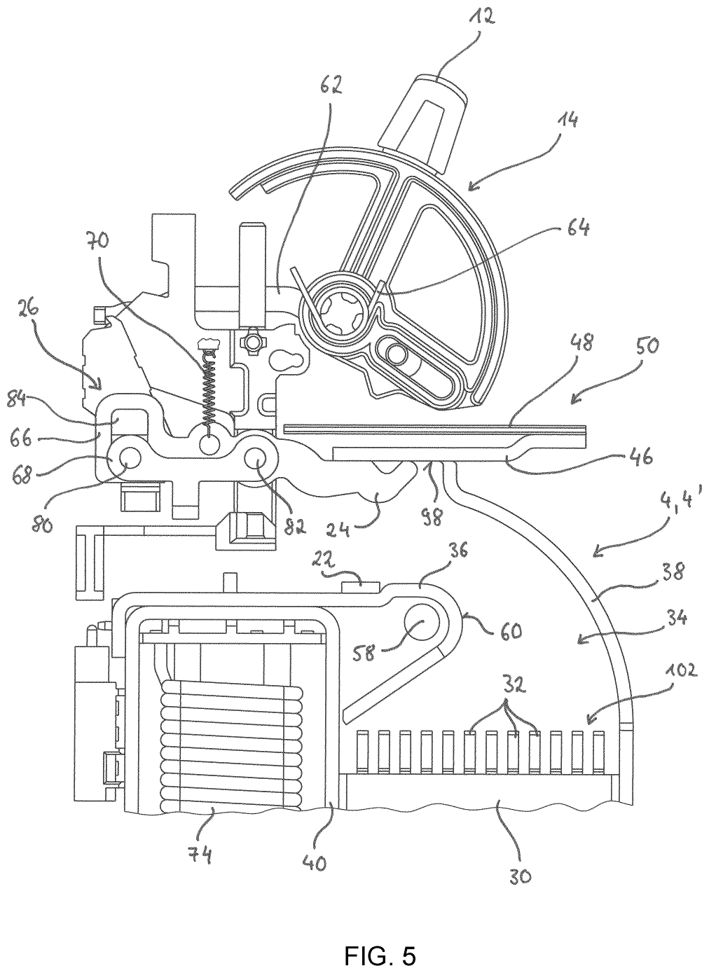

The circuit breaker 2 is preferably constructed in the manner of a rail-mounted device. The switching housing 6 accordingly has a shaping which is characteristic of devices of this kind and is stepped in a symmetrical manner in relation to a front side 8. A pivot lever 12 of a manual operating mechanism 14 (FIG. 4, FIG. 5) projects out of the switch housing 6 on a projecting central part 10 of the front side 8 for manual operation of the switching unit 4. The circuit breaker 2 is provided with a latching groove 18, which is typical of rail-mounted devices, for latching on a mounting rail, in particular on a top-hat rail, on a rear side 16 which is situated opposite the front side 8. Two end sides 20 of the switch housing 6 are disposed perpendicular to the front side 8 and the rear side 16, the circuit breaker 2 being lined up along the two end sides in the installed or assembled state of a rail-mounted device.

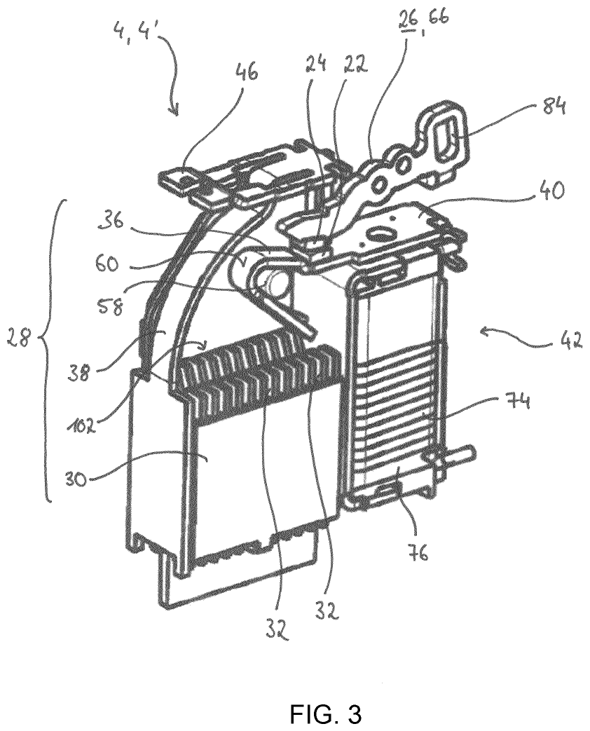

FIGS. 2 and 3 show a first and a second embodiment of the switching unit 4, 4′. The switching unit 4, 4′ has a mechanical contact system having a stationary fixed contact 22 and having a moving contact 24 which can move relative to the fixed contact. The moving contact 24 is supported by a switching arm 26 and can be moved or can be transferred between an open position, in which the fixed contact 22 and the moving contact 24 are at a distance from one another, and a closed position, in which the fixed contact 22 and the moving contact 24 are in electrically conductive physical contact, by using the switching arm.

Furthermore, the switching unit 4, 4′ has a quenching device 28 for quenching a (switching) arc which is produced when the contacts 22, 24 are opened. The quenching device 28 has a quenching chamber 30 which is constructed as a deionization chamber with a stack of splitter plates 32, which are disposed parallel to one another, inserted therein. In the figures, the splitter plates 32 are provided with reference signs merely by way of example.

Furthermore, the quenching device 28 has a prechamber 34, through the use of which the arc is guided from the contacts 22, 24 to the quenching chamber 30. The prechamber 34 has a first arc guide rail 36 and a second arc guide rail 38. In this case, the arc guide rail 36 is constructed in an integral manner with a magnet yoke 40 of a short-circuit release 42 of a release mechanism 44 of the circuit breaker 2 (FIG. 4, FIG. 5). The arc guide rail 38 is formed together with a current supply 46 as an integrally coherent sheet-metal part, wherein the current supply 46 at the same time forms a support for a bimetallic strip 48 of an overload release 50 of the release mechanism 44 (FIG. 4, FIG. 5).

Furthermore, the prechamber 34 has two insulating side walls 52 as lateral covering plates between which the arc guide rails 36, 38 are enclosed. The side walls 52 and the arc guide rails 36, 38 therefore form an arc guide space for guiding the arc from the contacts 22, 24 to the quenching chamber 30.

As is clear from FIG. 2, in particular, ferromagnetic shaped parts 54 are attached to the outer surfaces, that is to say to the surfaces which face the end sides 20, of the side walls 52 of the switching unit 4. The shaped parts 54 have an outer contour which is matched approximately to the profile of the arc guide rails 36, 38. The shaped parts 54 are constructed as a composite part with a molded-on insulation 56 which is disposed on that end side of the shaped parts 54 which faces the quenching chamber 30.

In the alternative construction of the switching unit 4′, two shaped magnets 54′ are provided instead of the ferromagnetic shaped parts 54. The shaped magnets 54′ have substantially the same shape or contour as the shaped parts 54. In particular, the shaped magnets 54′ are likewise provided with the insulation 56. This means that the shaped magnets 54′ and the shaped parts 54 differ substantially only in terms of the material used.

FIG. 3 shows the switching unit 4, 4′ of FIG. 2 with a side wall 52 removed. As is clear from FIG. 3, a heat-resistant permanent magnet 58 is disposed in the region of the fixed contact 22. In this case, in the embodiment of the switching unit 4′, the permanent magnet 58 can be provided in addition to the shaped magnets 54′. An embodiment of the switching unit 4′ without the permanent magnet 58 is likewise also conceivable for example.

Due to the use of the permanent magnet 58 in addition to the two shaped magnets 54′, the resulting magnetic field is bundled particularly intensely in the region of the fixed contact 22, and therefore the arc is moved particularly rapidly from the fixed contact onto the arc guide rail 36. To this end, the shaped magnets 54′—like the shaped parts 54—are each disposed on one of the side walls 52.

The permanent magnet 58 generates a magnetic field which guides the arc along the arc guide rail 36. To this end, the permanent magnet 58 is disposed radially on the inside of a—as seen from the fixed contact 22—convex bend or curvature 60 of the arc guide rail 36. Therefore, the permanent magnet 58 is disposed substantially within the profile of the arc guide rail 36.

The insulating side walls 52 insulate the ferromagnetic shaped parts 54 or the shaped magnets 54′ in relation to the arc, and therefore the shaped parts 54 or the shaped magnets 54′ are, in particular, not heated up beyond their respective Curie point, and therefore are changed to a paramagnetic state. The end sides of the side walls 52 project beyond the contact point of the contacts 22, 24, and therefore the contacts are enclosed substantially between the side walls 52 of the prechamber 34. Therefore, the arc is already “pinched” between the side walls 52 when it is produced, which results in an increase in voltage.

The shaped parts 54 of the switching unit 4 bundle the magnetic field of the permanent magnet 58. Due to the configuration of the permanent magnet 58 close to the fixed contact 22, the resulting magnetic force acts immediately on the arc produced and draws the arc down from the fixed contact 22 onto the arc guide rail 36. In other words, the arc, when it is produced by the magnetic field, is particularly rapidly commutated onto the arc guide rail 36 and guided to the quenching chamber 30.

Accordingly, the magnetic field is generated by the shaped magnets 54′ of the switching unit 4′ in addition or as an alternative to the magnetic field of the permanent magnet 58, and therefore commutates the arc from the fixed contact 22 onto the arc guide rail 36 due to the resulting magnetic force.

FIGS. 4 and 5 show a further embodiment of the switching unit 4, 4′. In this exemplary embodiment, the moving contact 24 is constructed in one piece, that is to say in one part or monolithically, at the free end of the switching arm 26. FIGS. 4 and 5 show the prechamber 34 without the side walls 52 and therefore without the shaped parts 54 or shaped magnets 54′ which, however, delimit the arc guide space of the prechamber 34 toward the end sides 20 in the assembled state in this embodiment too.

In addition to the switching unit 4, FIGS. 4 and 5 show the manual operating mechanism 14 and also the release mechanism 44 including the short-circuit release 42 and the overcurrent release 50. The manual operating mechanism 14 and the release mechanism 44 and also the switching arm 26 of the switching unit 4, 4′ form a switching lock, not provided with a specific designation, of the circuit breaker 2.

The manual operating mechanism 14 is substantially formed by the pivot lever 12 and also a coupling rod 62 and a torsion spring 64.

In the exemplary embodiment shown, the switching arm 26 is constructed with two elements and has a contact lever 66, with the moving contact 24 at the free end, and a latching lever 68. The switching arm 26 is pretensioned by using a tension spring 70.

The release mechanism 44 includes a release slide 72 and the overload release 50, which is formed substantially from the bimetallic strip 48, and also the electromagnetic short-circuit release 42. The short-circuit release 42 includes a magnet coil 74 and a magnet core 76 and also the magnet yoke 40 and a magnet armature 78. In this case, the magnet armature 78 is coupled to a plastic rod, not specifically shown, which is held in a pretensioned manner by using a compression spring.

In the assembled state, the latching lever 68 of the switching arm 26 is mounted in such a way that it can pivot about a rotation shaft 80 which is fixed to the housing. The contact lever 66 is connected in an articulated manner to the latching lever 68 by using a rotary joint 82, and therefore the switching arm 26 inherently has a certain degree of flexibility. The resulting relative mobility of the contact lever 66 with respect to the latching lever 68 is limited by an elongate hole 84 at the rear end, that is to say the end which is averted from the moving contact 24, of the contact lever 66 into which the rotation shaft 80 engages in the manner of a linear guide.

The moving contact 24 interacts with the fixed contact 22 in order to switch an electrical circuit. In this case, the fixed contact 22 is attached, in particular on a top side of the magnet yoke 40, to the attachment of the arc guide rail 36 which is integrally connected to the magnet yoke.

FIG. 4 shows the switching unit 4, 4′ in a closed state or in a closed position of the switching arm 26 in which the free end of the contact lever 66, which free end forms the moving contact 24, bears against the fixed contact 22. In this closed position, an electrically conductive connection is produced between a feed connection 86 or coupling contact 88 and a load connection 90 of the circuit breaker 2, which electrically conductive connection passes through a busbar 92, the magnet coil 74, the magnet yoke 40, the fixed contact 22, the contact lever 66 with the moving contact 24, the bimetallic strip 48 and an adjoining busbar 94. The electrical connection between the rear end of the contact lever 66 and the bimetallic strip 48 and also between the bimetallic strip 48 and the busbar 94 is closed by using a stranded connection 96, which is merely schematically illustrated in FIG. 4, in each case.

The core component of the release mechanism 44 is the release slide 72 which is operated both by the bimetallic strip 48 of the overload release 50 and also by the plastic rod of the short-circuit release 42, which plastic rod is coupled to the magnet armature 78, and resets the switching arm 26 from the closed position to the open position (FIG. 5) given operation of one of the releases 50 or 42.

A short circuit in an electrical circuit which is connected to the connections 86 and 90 leads to a sudden increase in the current flowing through the magnet coil 74. The sharp increase in current causes a proportional increase in the magnetic field which is generated by the magnet coil 74, as a result of which the magnet armature 78 is operated. Due to the resulting movement, the release slide 72 is operated and therefore the contacts 22 and 24 are separated.

In this case, FIG. 5 shows a final state of a release process in which the moving contact 24 bears against a stop surface 98 which forms an attachment of the second arc guide rail 38, which attachment is situated at a distance opposite the fixed contact 22.

During the course of a release process of this kind, the (switching) arc is produced between the fixed contact 22 and the moving contact 24 which lifts away from the fixed contact, the (switching) arc leading to intense heating and, in the long term, to erosion of the contacts 22 and 24. In this case, the quenching device 28 serves for rapid effective quenching of the arc.

When the contacts 22 and 24 are opened, the current flow within the contact lever 66, the arc section and the section of the magnet yoke 40 which is situated opposite the contact lever 66 acts as a current loop. This current loop, in addition to a Lorentz force due to the magnetic field of the permanent magnet 58 that is bundled by using the shaped parts 54, exerts an induction force on the arc, which induction force drives the arc in the direction of the quenching chamber 30.

When the switching arm 26 strikes the stop surface 98, the conductive connection between the bimetallic strip 48, the stranded connections 96 (FIG. 4) and the contact lever 66 is short-circuited through the current supply 46. The shaping of the metal strip from which the current supply 46 and the arc guide rail 38 are integrally formed ensures that the sign of the induction effect of the current flow on the arc is maintained during this process.

The arc guide rail 38 is cut out of the current supply 46 in such a way that the arc guide rail 38, in the region of the stop surface 98, is guided along the contact lever 66 which bears against it in its open position, and enters the current supply 46 only after the moving contact 24—as seen along the contact lever 66 from the moving contact 24. The current which is guided from the fixed contact 22 through the arc section to the moving contact 24 therefore has to flow a certain distance in the direction of the elongate hole-side lever end, even if the contact lever 66 is already bearing against the stop surface 98, within the contact lever 66 or the arc guide rail 38, in the same way as before the contact lever 66 strikes, until it is diverted in the opposite direction through the current supply 46. In this case, the arc guide rail 38 is cut, in particular centrally, out of the current supply 46 in order to ensure as symmetrical a current flow as possible in the transition region.

With regard to the electrodynamic interaction of the current path, the magnet yoke 40 in which the guide rail 36 is integrated is not closed in a circular manner around the magnet coil 74 either. Instead, the magnetic yoke 40 is interrupted on a bottom side, which faces the magnet armature 78, by a narrow air gap 100 (FIG. 4). In this case, the air gap 100 is dimensioned in such a way that it does not significantly adversely affect the magnetic flow within the magnet yoke 74 but effectively suppresses a current flow through the gap section. Instead, a current path which is directed in the direction of the fixed contact 22 and the arc guide rail 36 is constantly forced within the magnet yoke 40. In the context of the present description, the direction of the current path is specified independently of the actual direction of current flow as starting from the feed connection 86 or coupling contact 88 and oriented toward the load connection 90.

Overall, the geometric characteristics of the current flow within the circuit breaker 2 and the resulting induction effect are retained over the entire release process until the arc is extinguished.

Under the induction effect and also in particular due to the bundled magnetic field of the permanent magnet 58, the arc becomes detached from the contacts 22 and 24 at the latest after the contact lever 66 strikes the stop surface 98, and moves to the adjoining arc guide rails 26 and 38. This process is referred to as commutation. The arc then migrates, in a manner enclosed by the side walls 52 and shaped parts 54 or the shaped magnets 54′, furthermore under the influence of the electrodynamic forces, along the arc guide rails 36 and 38 in the arc guide space, which is formed between them, of the prechamber 34 to an inlet 102 of the quenching chamber 30.

The arc enters the quenching chamber 30 through the inlet 102 and is split into a number of partial arcs by the splitter plates 32. The splitter plates 32 promote quenching of the arc in a manner which is known per se by way of the total voltage which is dropped across the entire arc section being multiplied and the arc being cooled.

The invention is not restricted to the exemplary embodiments described above. Instead, other variants of the invention can also be derived therefrom by a person skilled in the art without departing from the subject matter of the invention. In particular, all of the individual features described in connection with the exemplary embodiment can furthermore also be combined with one another in a different way without departing from the subject matter of the invention.

The following is a summary list of reference numerals and the corresponding structure used in the above description of the invention:
2 Circuit breaker
4, 4′ Switching unit
6 Switching housing
8 Front side
10 Central part
12 Pivot lever
14 Manual operating mechanism
16 Rear side
18 Latching groove
20 End side
22 Fixed contact
24 Moving contact
26 Switching arm
28 Quenching device
30 Quenching chamber
32 Splitter plate
34 Prechamber
36, 38 Arc guide rail
40 Magnet yoke
42 Short-circuit release
44 Release mechanism
46 Current supply
48 Bimetallic strip
50 Overload release
52 Side wall
54 Shaped part
54′ Shaped magnet
56 Insulation
58 Permanent magnet
60 Curvature/bend
62 Coupling rod
64 Torsion spring
66 Contact lever
68 Latching lever
70 Tension spring
72 Release slide
74 Magnet coil
76 Magnet core
78 Magnet armature
80 Rotation shaft
82 Rotary joint
84 Elongate hole
86 Feed connection
88 Coupling contact
90 Load connection
92, 94 Busbar
96 Stranded connection
98 Stop surface
100 Air gap
102 Inlet

1. A circuit breaker, comprising:
a switching unit for interrupting an electrical circuit, said switching unit including:
a stationary fixed contact;
a moving contact configured to be moved relative to said fixed contact and to be transferred from a closed position to an open position;
a quenching device for quenching an arc produced upon opening said contacts, said quenching device including a quenching chamber and a prechamber for guiding the arc from said contacts to said quenching chamber, said prechamber having two insulating side walls and a pair of arc guide rails disposed between said side walls;
ferromagnetic shaped parts each disposed on a respective one of said side walls; and
a permanent magnet disposed in a region of said fixed contact, said permanent magnet forming a magnetic field guiding the arc along one of said arc guide rails.

2. The circuit breaker according to claim 1, which further comprises two shaped magnets for guiding the arc in addition to said permanent magnet.

3. The circuit breaker according to claim 1, wherein said one arc guide rail is guided to said fixed contact, and said one arc guide rail has a curved or bent profile from said fixed contact toward said quenching chamber.

4. The circuit breaker according to claim 3, wherein said quenching chamber has a first side wall, said one arc guide rail connects said fixed contact to said first side wall of said quenching chamber, and said one arc guide rail has a convex profile starting from said fixed contact.

5. The circuit breaker according to claim 4, wherein said first side wall is formed by a magnet yoke of a short-circuit release.

6. The circuit breaker according to claim 3, wherein said permanent magnet is disposed in a region of the bend or curvature of said one arc guide rail.

7. The circuit breaker according to claim 6, wherein said permanent magnet is disposed radially on an inside of the bend or curvature.

8. The circuit breaker according to claim 1, wherein said ferromagnetic shaped parts each have an electrical insulation at end sides oriented toward said quenching chamber.

9. The circuit breaker according to claim 8, wherein said shaped parts are insert parts encapsulated by injection-molding with said electrical insulation in the region of the end sides.

10. The circuit breaker according to claim 1, wherein said quenching chamber is constructed as a deionization chamber with an arc splitter stack.

11. The circuit breaker according to claim 1, which further comprises:
a pivotable switching arm, said moving contact being disposed on said pivotable switching arm;
a manual operating mechanism coupled to said pivotable switching arm for manually adjusting said pivotable switching arm between the open position and the closed position; and
a release mechanism coupled to said pivotable switching arm for automatically returning said pivotable switching arm to the open position when a release condition occurs.

12. The circuit breaker according to claim 11, which further comprises a switching housing, said switching unit, said release mechanism and said manual operating mechanism being at least partially accommodated together in said switching housing.

13. A circuit breaker, comprising:
a switching unit for interrupting an electrical circuit, said switching unit including:
a stationary fixed contact;
a moving contact configured to be moved relative to said fixed contact and to be transferred from a closed position to an open position;
a quenching device for quenching an arc produced upon opening said contacts, said quenching device including a quenching chamber and a prechamber for guiding the arc from said contacts to said quenching chamber, said prechamber having two insulating side walls and a pair of arc guide rails disposed between said side walls; and
shaped magnets each disposed on a respective one of said side walls, said shaped magnets together forming a magnetic field guiding the arc along one of said arc guide rails.

14. The circuit breaker according to claim 13, wherein said one arc guide rail is guided to said fixed contact, and said one arc guide rail has a curved or bent profile from said fixed contact toward said quenching chamber.

15. The circuit breaker according to claim 14, wherein said quenching chamber has a first side wall, said one arc guide rail connects said fixed contact to said first side wall of said quenching chamber, and said one arc guide rail has a convex profile starting from said fixed contact.

16. The circuit breaker according to claim 15, wherein said first side wall is formed by a magnet yoke of a short-circuit release.

17. The circuit breaker according to claim 14, wherein said permanent magnet is disposed in a region of the bend or curvature of said one arc guide rail.

18. The circuit breaker according to claim 17, wherein said permanent magnet is disposed radially on an inside of the bend or curvature.

19. The circuit breaker according to claim 13, wherein said shaped magnets each have an electrical insulation at end sides oriented toward said quenching chamber.

20. The circuit breaker according to claim 19, wherein said shaped magnets are insert parts encapsulated by injection-molding with said electrical insulation in the region of the end sides.

21. The circuit breaker according to claim 13, wherein said quenching chamber is constructed as a deionization chamber with an arc splitter stack.

22. The circuit breaker according to claim 13, which further comprises:
a pivotable switching arm, said moving contact being disposed on said pivotable switching arm;
a manual operating mechanism coupled to said pivotable switching arm for manually adjusting said pivotable switching arm between the open position and the closed position; and
a release mechanism coupled to said pivotable switching arm for automatically returning said pivotable switching arm to the open position when a release condition occurs.

23. The circuit breaker according to claim 22, which further comprises a switching housing, said switching unit, said release mechanism and said manual operating mechanism being at least partially accommodated together in said switching housing.
